(19) United States
(12) Patent Application Publication
(10) Pub. No.: US 2007/0205615 A1
(43) Pub. Date: Sep. 6, 2007

(54) Sash Lock Assembly Having Forced Entry Resistance

(75) Inventors: Mark B. Eenigenburg, Lansing, IL (US); Edward C. Flory, Crown Point, IN (US); Michael A. Tyler, Mokena, IL (US)

Correspondence Address: BANNER & WITCOFF, LTD., TEN SOUTH WACKER DRIVE, SUITE 3000, CHICAGO, IL, 60606, US

(73) Assignee: Newell Operating Company, Atlanta, GA (US)

(21) Appl. No.: 11/677,253

(22) Filed: Feb. 21, 2007

Related U.S. Application Data
(60) Provisional application No. 60/775,191, filed on Feb. 21, 2006.

(51) Int. Cl. E05C 3/04

(52) U.S. Cl. 292/241

(57) ABSTRACT

A sash lock assembly is used with a sash window assembly having an upper sash window and a lower sash window slidable within tracks of a master frame. The sash lock assembly includes a keeper adapted to be connected to the upper sash window, a housing adapted to be connected to the lower sash window, a rotor positioned within the housing, a handle having a shaft extending through the housing and connected to the rotor, and a selectable stop member. The rotor is moveable between a locked position, wherein the rotor engages the keeper, and an unlocked position, wherein the rotor does not engage the keeper. Movement of the handle moves the rotor between the locked position and the unlocked position. The anti-rotation device includes a stop member and is moveable between a first position, wherein the stop member blocks movement of the rotor from the locked position to the unlocked position, and a second position, wherein the stop member does not block movement of the rotor.

### CROSS-REFERENCE TO RELATED APPLICATIONS

This application claims the benefit of U.S. Provisional Patent Application Ser. No. 60/775,191, filed Feb. 21, 2006, which is incorporated by reference herein and made part hereof.

### TECHNICAL FIELD

The present invention relates to sash window hardware and, more particularly, to a sash lock assembly for use in sash windows.

### BACKGROUND OF THE INVENTION

A sash window assembly having a pivotal sash window adapted for installation in a master frame is well-known. The master frame typically has opposed, vertically extending guide rails to enable vertical reciprocal sliding movement of the sash window in the master frame while cooperatively engaged with the guide rails. The sash window may have an upper sash window and a lower sash window. The sash window also has a top sash rail, a base and a pair of stiles cooperatively connected together at adjacent extremities thereof to form a sash frame.

Hardware is associated with the sash window assembly, such as tilt-latches and a sash lock assembly. Tilt-latches are supported by the top sash rail and releasably engage the guide rails to allow the sash window to pivot from the master frame. The sash lock assembly provides a locking mechanism between the upper sash window and the lower sash window. The sash lock assembly typically has one component that is supported by the top sash rail of the lower sash window and another component that is supported by the base of the upper sash rail. The sash lock components cooperate to provide the locking mechanism wherein the lower sash window and the upper sash window are prevented from sliding within the master frame.

One problem associated with typical sash locks is their ability to be manipulated by an intruder from outside the sash window assembly. That is, sash locks generally include some type of rotatable handle arm and cam. The handle is rotatable from a locked to an unlocked position. With some sash locks, the handle arm or cam may be manipulated from the outside by a skilled intruder using a thin knife, stiff wire, or other diabolical tool of intrusion. Accordingly, while the sash lock assemblies provide a number of advantageous features, they nevertheless have certain limitations. The present invention seeks to overcome certain of these limitations and other drawbacks of the prior art, and to provide new features not heretofore available.

### SUMMARY OF THE INVENTION

A sash lock assembly for a sash window assembly is disclosed. The sash window assembly includes an upper sash window and a lower sash window slidable within tracks of a master frame. The sash lock assembly comprises a keeper, and a lock assembly. The keeper is adapted to be connected to the upper sash window.

The lock assembly includes a housing, a rotor or cam, an operator or handle, and an anti-rotation device. The housing is adapted to be connected to the lower sash window. The rotor is positioned within the housing and is moveable between a locked position, wherein the rotor engages the keeper, and an unlocked position, wherein the rotor does not engage the keeper. The rotor engages the keeper when the sash lock assembly is in the locked position. The handle includes a shaft extending through the housing, connecting it to the rotor. Movement of the handle moves the rotor between the locked position and the unlocked position. The anti-rotation device includes a stop member and is moveable between a first position, wherein the stop member blocks movement of the rotor from the locked position to the unlocked position, and a second position, wherein the stop member does not block movement of the rotor.

According to one aspect of the invention, the anti-rotation device also includes an actuator accessible from outside the housing. The actuator includes a gripping surface to facilitate manipulation of the actuator by a user.

According to another aspect of the invention, the actuator extends through a slot in the housing. The slot is defined by an engaging surface, and the actuator abuts the engaging surface when the stop member is in the first position.

According to another aspect of the invention, the anti-rotation device also includes a biasing means for biasing the stop member toward the first position.

These and other objects and advantages will be made apparent from the following description of the drawings and detailed description of the invention.

### BRIEF DESCRIPTION OF THE DRAWINGS

To understand the present invention, it will now be described by way of example, with reference to the accompanying drawings in which:

FIG. 1 is a perspective view of a sash window assembly;

FIG. 2 is a perspective view of a prior art locking assembly;

FIG. 3 is a perspective view of a locking assembly of the present invention, shown in the locked position;

FIG. 4 is a rear perspective view of the locking assembly of FIG. 3;

FIG. 5 is a front view of the locking assembly of FIG. 3;

FIG. 6 is a rear view of the locking assembly of FIG. 3;

FIG. 7 is a side view of the locking assembly of FIG. 3;

FIG. 8 is a top view of the locking assembly of FIG. 3;

FIG. 9 is a bottom view of the locking assembly of FIG. 3;

FIG. 10 is a bottom perspective view of the locking assembly of FIG. 3;

FIG. 11 is a bottom rear perspective view of the locking assembly of FIG. 3;

FIG. 12 is a bottom view of the locking assembly of FIG. 3, illustrating movement of a rotor and an anti-rotation device;

FIG. 13 is a perspective view of an anti-rotation device of the locking assembly of FIG. 3; and

FIG. 14 is a bottom rear perspective view of the anti-rotation device of FIG. 13.

### DETAILED DESCRIPTION

While this invention is susceptible of embodiment in many different forms, there is shown in the drawings, and will herein be described in detail, preferred embodiments of the invention with the understanding that the present disclosure is to be considered as an exemplification of the principles of the invention and is not intended to limit the broad aspect of the invention to the embodiments illustrated.

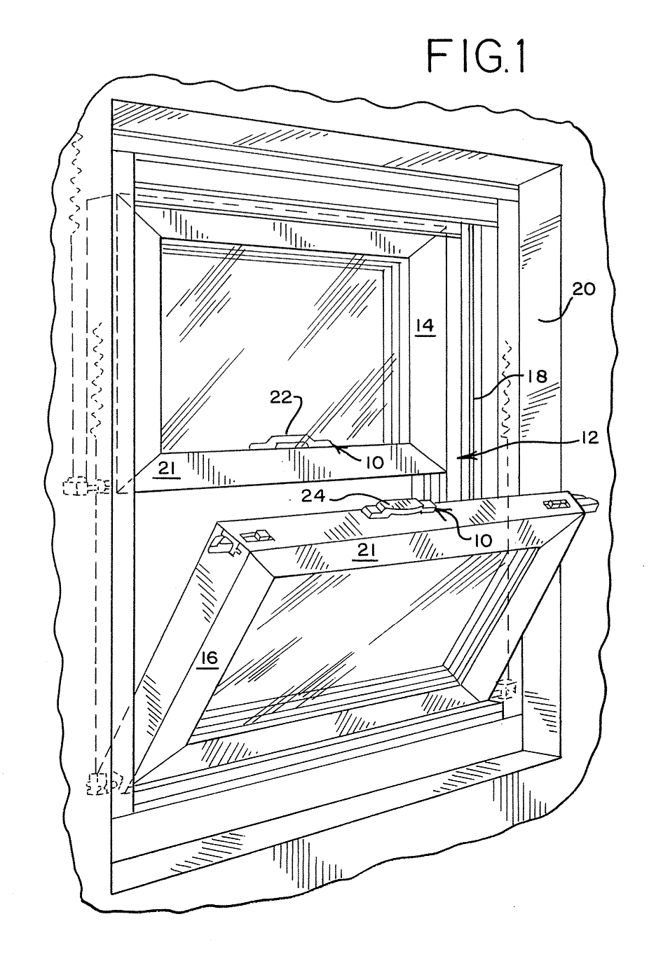

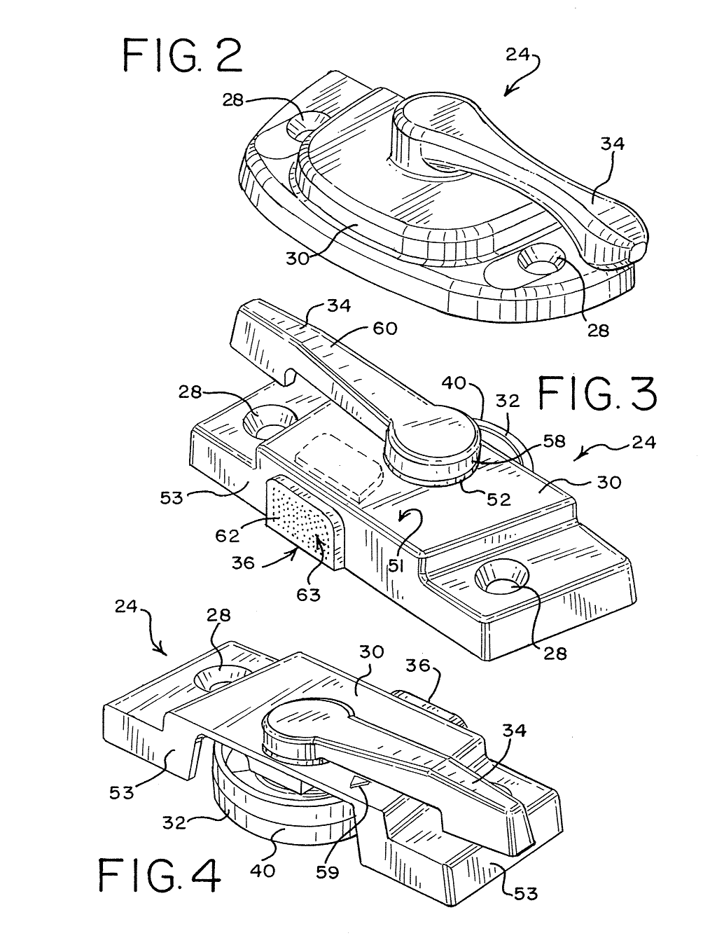

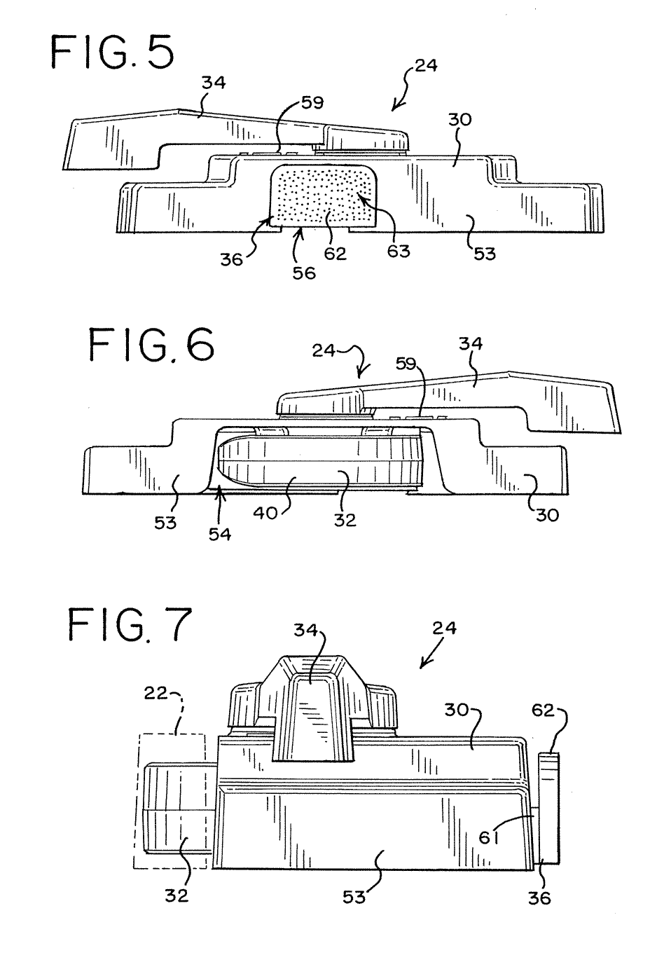

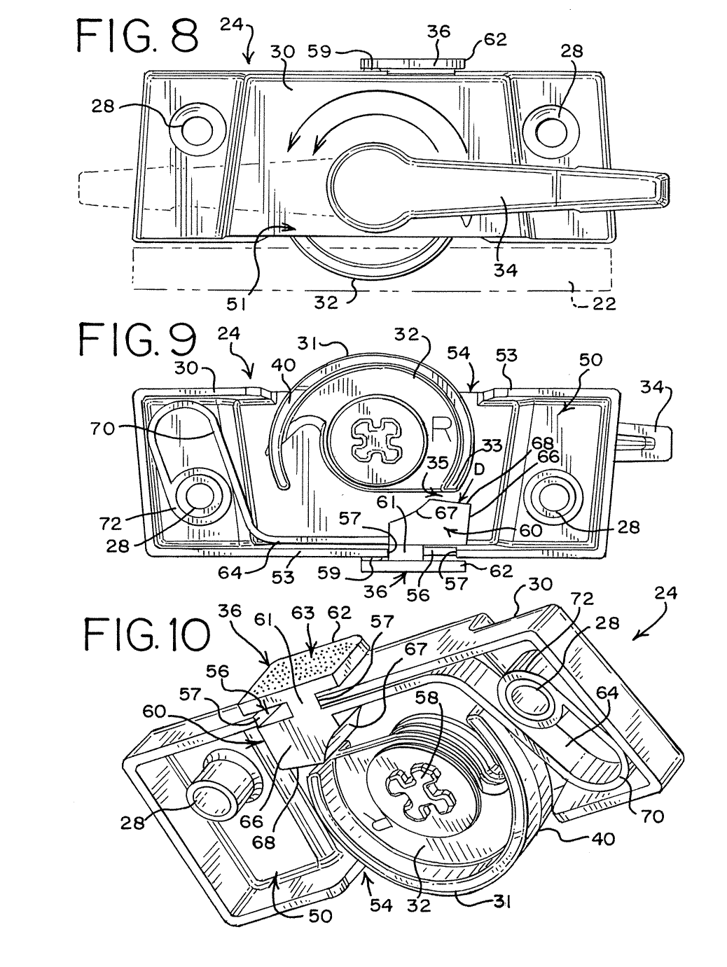

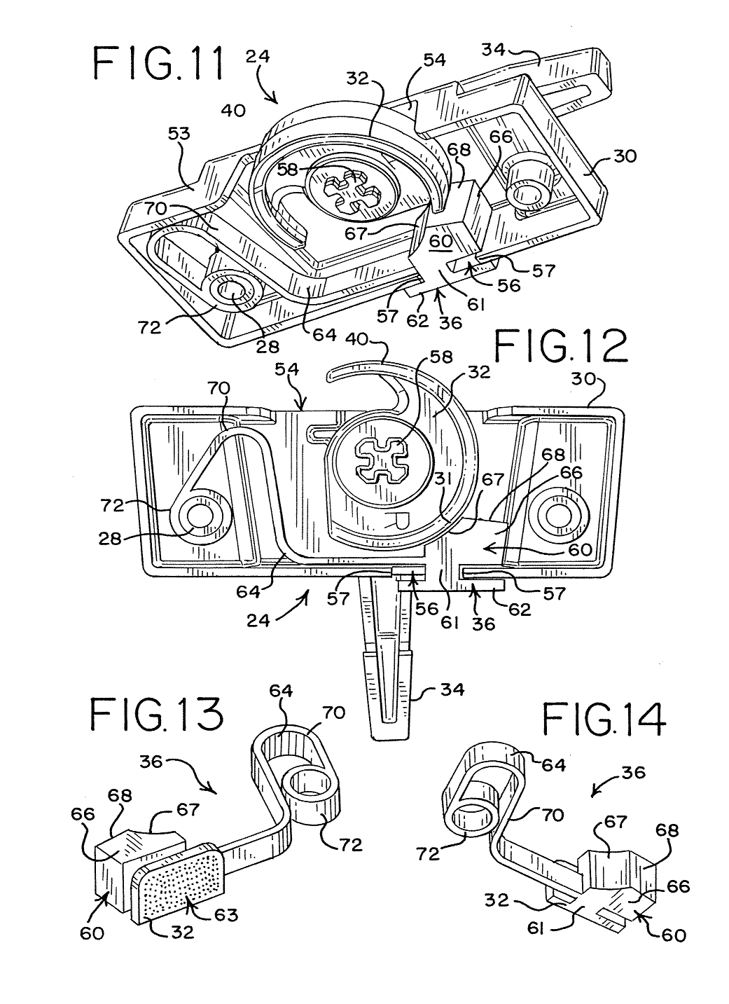

A sash lock assembly 10 for a sash window assembly 12 is illustrated in the FIGS. and described herein. As generally shown in FIG. 1, the sash window assembly 12 includes an upper sash window 14 and a lower sash window 16. Each of the sash windows 14,16 is mounted within opposed guide rails 18 on a master frame 20. At least one of the sash windows 14,16 is slidable within the master frame 20 relative to the other of the sash windows 14,16. Each sash window 14,16 has a pair of horizontal frame members 21, or rails 21. The upper rail 21 may be considered a top rail 21 and the lower rail may be considered a base rail 21.

The sash window assembly 12 described herein is typically made from vinyl extrusions known in the art. While the present invention can be used with any type of sash window assembly 12, the present invention is most preferably used with sash windows 14, 16, and a master frame 20 made of vinyl. Further, it is contemplated that the sash window assembly 12 could be made from wood, masonite or press board, or from extrusions or pulltrusions that are filled with fiberglass, epoxy, plastic, or wood chips, or from other materials, including aluminum.

The sash lock assembly 10 includes a keeper 22 and a locking assembly 24. The keeper 22 is generally a known structure. The keeper 22 includes a keeper surface and a pair of mount holes for mounting the keeper 22 to one of the frame members 21, as described more fully below. In the embodiment described, the keeper 22 is mounted to the lower frame member or base rail 21 of the upper sash window 14 (FIG. 1). Generally, the keeper 22 is mounted with a pair of screws or other fasteners extending through the mount holes and secured to the base rail 21. Typically, the keeper 22 is mounted near the center of the base rail 21.

A prior art locking assembly 24 is illustrated in FIG. 2, and includes a housing 30, a cam (not shown), a handle 34, and a pair of mount passages 28 for fastening the locking assembly 24 to one of the sash windows 14,16.

One exemplary embodiment of the locking assembly 24 of the present invention is shown in FIGS. 3-12 and generally includes a housing 30, a rotor or cam 32, a handle 34, and a forced entry resistance device or anti-rotation device 36. The rotor 32 is moveable between a locked position, wherein the rotor 32 engages the keeper 22 (shown by broken lines in FIGS. 7 and 8), and an unlocked position, wherein the rotor 32 does not engage the keeper 22. The handle 34 is connected to the rotor 32 such that movement of the handle 34 moves the rotor 32 between the locked position and the unlocked position. FIGS. 8 and 12 illustrate movement of the handle 34 and rotor 32 from the locked position to the unlocked position.

The housing 30 has an upper surface 51 and several sidewalls 53 depending from the upper surface 51 defining an interior cavity 50 (FIG. 9). In the embodiment illustrated in FIGS. 3-12, the housing 30 includes a central aperture 52 in communication with the interior cavity 50, a pair of mount passages 28 extending through the housing 30, a rear opening 54 in the rear of the housing 30, and a slot 56. The mount passages 28 are adapted to receive fasteners (not shown) therethrough and, in the embodiment shown in FIGS. 8-12 are hollow tubes extending downward from the top of the housing 30. Additionally, the mount passages 28 shown are tapered inwardly at the top. The rear opening 54 is defined in the rear sidewall 53 and permits the rotor 32 to extend out of the housing 30 to engage the keeper 22. The central aperture 52 allows the handle 34 to be connected to the rotor 32. In the embodiment shown in FIGS. 3-12, the slot 56 is located in the front sidewall 53 of the housing and provides access to the anti-rotation device 36 from outside the housing 30, as described in greater detail below. As shown in FIGS. 9-12, the ends of the slot 56 are defined by engaging surfaces 57 to limit movement of the anti-rotation device 36. The upper surface 51 of the housing 30 illustrated has a stepped configuration, with a pair of recessed portions defining a pair of lower surfaces on either side of the upper surface. Additionally, the housing 30 may have indicia 59 thereon to indicate the position of the rotor 32 and/or the position of the anti-rotation device 36, or to indicate the effect of moving the rotor 32 and/or the anti-rotation device 36 in a specific direction.

The rotor or cam 32 includes a locking member 40. The rotor 32 is positioned within the housing 30 and is rotatably mounted. The rotor 32 is moveable between a locked position, wherein the rotor 32 engages the keeper 22, and an unlocked position, wherein the rotor 32 does not engage the keeper 22, as discussed above. In the locked position, the locking member 40 extends out of the rear opening 54 of the housing 30 and engages the keeper 22, preventing sliding of either sash window 14,16 and holding the sash window assembly 12 closed.

The handle 34 is located above the housing 30. The handle 34 extends out over the housing 30 so that it can be rotated about the housing 30. In the embodiment shown in FIGS. 3-12, the handle 34 has a shaft 58 extending downwardly and a lever 60 extending outwardly. The shaft 58 connects the rotor 32 to the handle 34 through the aperture 52 of the housing 30. It is understood that the handle 34 and the shaft 58 can be a single integral member. In this way, the rotor 32 and handle 34 are rotatably mounted to the housing 30. Thus, movement of the handle 34 moves the rotor 32 between the locked position and the unlocked position. That is, there is no relative movement between the rotor 32 and handle 34, however, the rotor 32 and handle 34 rotate together with respect to the housing 30. It is understood that there may be a certain amount of “play” in the connection between the rotor 32 and the handle 34. Thus, the handle 34 may be able to pivot a certain distance with respect to the rotor. A spring washer (not shown) can be used in this connection to assist with this movement.

The anti-rotation device or forced entry resistance device 36 selectably prevents movement of the rotor 32 from the locked position to the unlocked position in order to resist forced entry. One exemplary embodiment of the anti-rotation device 36 is best illustrated in FIGS. 9-14 and includes a stop member 60, an actuator 62, and a biasing means 64. The anti-rotation device 36 is operably associated with housing 30. The actuator 62 is accessible from outside the housing 30 to move the stop member 60. The stop member 60 is generally moveable between a first position, or secure position (shown in FIGS. 9-11), where the stop member 60 blocks movement of the rotor 32 from the locked position to the unlocked position, and a second position, or free position (shown in FIG. 12), wherein the stop member 60 does not block movement of the rotor 32 and the rotor 32 can freely rotate. In one exemplary embodiment, the anti-rotation device 36 is made from spring steel, but may also be made from other suitable metals, other plastics, or another suitable material. Additionally, different components of the anti-rotation device 36 may be made from different materials. For example, the biasing means 64, the stop member 60, and/or the actuator 62 may be made from a plastic or other polymeric material.

The actuator 62 shown in FIGS. 3-12 has a gripping surface 63 thereon to facilitate manipulation of the actuator 62 by a user, such as by sliding with a thumb. The gripping surface 63 may have ridges, projections, or other friction-enhancing surface or structure that may be either integral with the actuator 62 or affixed to the actuator 62. A portion of the actuator 62 abuts the engaging surfaces 57 of the slot 56 in the housing 30 to limit movement of the anti-rotation device 36. For this purpose, the actuator 62 shown in FIGS. 9-14 has a connector 61 extending through the slot 56 in the housing 30 and connected to the stop member 60. The connector 61 abuts the engaging surfaces 57 at either end of the slot 56 to limit movement of the anti-rotation device 36. As shown in FIGS. 9-11, the connector 61 abuts one of the engaging surfaces 57 when the stop member 60 is in the first position, due to the force exerted by the biasing means 64. Additionally, the connector 61 abuts the other engaging surface 57 to prevent movement of the actuator 62 too far past the second position.

The biasing means 64 biases the stop member 38 toward the first position. The biasing means 64 of the embodiment illustrated in FIGS. 9-12 is a biasing means 64 that is located completely within the housing 30. One end of the spring 64 is connected to one of the cylindrical mount passages 28 by a press fit or boss connection, and the other end is connected to the stop member 60. As illustrated in FIGS. 9-14, the spring 64 has a mounting arm 70 having a loop 72 that encircles the mount passage 28 to connect the spring 64 to the housing 30. In some embodiments, the loop 72 may be formed by a winding of the end portion of the spring 64. When no external force acts upon the anti-rotation device 36, the spring 64 pulls upon the stop member 38 to maintain the stop member 38 in the first position, blocking rotation of the rotor 32. The biasing means 64 may also be a different type of spring, another type of resilient member, or other any other such suitable device known in the art, and may be mounted in a different configuration. It is also understood that the locking assembly 24 may have suitable structure to support the stop member 60 in its first and second positions without the biasing means 64.

The stop member 60 illustrated in FIGS. 9-14 is a resilient block 66 that abuts the rotor 32 to prevent rotation of the rotor 32 from the locked position. The block 66 has a contoured surface 67 and an abutment surface 68 thereon. The abutment surface 68 abuts the rotor 32 to block rotation of the rotor 32 and, as shown in FIG. 9, is angled to be substantially normal (perpendicular) to the rotor 32 at the point of abutment. In other words, the abutment surface 68 is angled such that when the abutment surface 68 engages the rotor 32, the abutment surface 68 is substantially perpendicular to the direction of movement D of a portion 33 of the rotor 32 engaging the abutment surface 68. The perpendicular abutment of the rotor 32 and the abutment surface 68 tends to push or force the stop member 60 toward the first position and minimizes or eliminates tangential forces that may lead to slipping between the rotor 32 and the abutment surface 68. Additionally, in the embodiment shown in FIGS. 9-11, a gap 35 is maintained between the abutment surface 68 and the rotor 32 when the rotor 32 is fully rotated to the locked position, which permits a certain amount of rotation of the rotor 32 prior to engaging the abutment surface 68. The gap 35 improves functioning of the anti-rotation mechanism 36, such as by permitting sufficient space for the stop member 60 to snap back to the first position when the rotor 32 is moved to the locked position.

The contoured surface 67 is contoured similarly to the contour of the outer surface 31 of the rotor 32 to allow the rotor 32 to slide smoothly against the contoured surface 67. As shown in FIG. 12, the outer surface 31 of the rotor is curved, and the contoured surface 67 is curved similarly to the curved outer surface 31 of the rotor 32. Thus, the rotor 32 slides smoothly against the contoured surface 67 when the rotor 32 is moved between the locked position and the unlocked position. This is desirable to create smooth functioning of the locking assembly 24, because the force exerted by the biasing means 64 generally causes the contoured surface 67 to contact the side of the rotor 32 after the rotor 32 is moved clear of the abutment surface 68.

In other embodiments, the anti-rotation device 36 may be differently configured. For example the slot 56 may be elsewhere on the housing 30, such as in the upper surface 51 of the housing 30, and the actuator 62 may extend upward from the stop member 60 accordingly. The phantom lines in FIG. 3 illustrate such an embodiment, where the actuator 62A extends from the upper surface 51 of the housing 30. Additionally, the stop member 60 may alternately be a tab, tongue, or other similar device suited for abutting the rotor 32. Further, the rotor 32 may have a tab, tongue, or other similar structure that abuts the stop member 60. Still further, the anti-rotation device 36 may operate by rotation, rather than sliding action. The actuator 62 may be a post, projection, or other structure, rather than a flat surface. Still other embodiments are included within the scope of the present invention.

The locking assembly 24 is mounted to the upper frame member 21, or top rail 21, of the lower sash window 16. It is mounted such that it is immediately adjacent to the keeper 22 when the upper sash window 14 is in its upper most position within the master frame 20 and the lower sash window 16 is in its lower most position within the master frame 20. In mounting the locking assembly 24, a screw or other fastener (not shown) passes through one of the mount passages 28 of the locking assembly 24 and secured to the top rail 21 (see FIG. 1). Another screw or fastener is then used to secure the housing 30 to the top rail 21 via its other mount passage 28.

The locking assembly 24 depicted in the FIG. 3 is configured such that the handle 34 rotates in a counterclockwise direction when rotating from the locked to the unlocked position. This movement is illustrated by the arrows and phantom lines in FIG. 8. However, it is understood that the locking assembly 24 may be configured such that its handle 34 rotates in a clockwise direction in moving from the locked to the unlocked position. In this instance, the anti-rotation device 36 may be mounted on the other side of the lock assembly.

In operation, when the handle 34 is in the locked position as shown in FIGS. 3-11, the locking member 40 of the rotor 32 is positioned outside of the housing 30. In this position, the locking member 40 engages the keeper 22, locking the sash window assembly 12. Additionally, the stop member 60 is in the first position, and will abut the rotor 32 if the rotor is attempted to be moved from the locked position. Thus, if the rotor 32 or handle 34 were attempted to be manipulated from outside of the sash window assembly 12, the anti-rotation mechanism 36 would prevent movement, thus preventing forcible entry. To rotate the rotor 32 to the unlocked position, the actuator 62 must be manipulated to move the stop member 60 from the first position to the second position. In the second position, the abutment surface 68 of the stop member 60 does not abut the rotor 32, and the rotor 32 can be rotated to clear the abutment surface 68 of the stop member 60. Once the rotor 32 is moved to clear the abutment surface 68, the actuator 62 can be released, and the stop member 60 will move back toward the first position due to the force of the biasing means 64. The contoured surface 67 then contacts the outer surface of the rotor 32, preventing the stop member 60 from returning to the first position, and the rotor 32 will move smoothly against the contoured surface 67.

When the handle 34 in the unlocked position, the lower sash window 16 can slide relative to the master frame 20 such as to raise the lower sash window 16 to open the sash window assembly 12. When it is desired to once again place the sash lock assembly in its locked position, the upper sash window 14 is maintained in its upper most position within the master frame 20 and the lower sash window 16 is lowered to its lower most position within the master frame 20. This brings the locking assembly 24 to a position immediately adjacent the keeper 22. The handle 34 is then rotated to move the rotor 32 to the locked position. This rotates the locking member 40 to a position external to the housing 30 and causes the rotor 32 to engage the keeper 22. As the rotor 32 moves to the locked position, the rotor 32 will clear the contoured surface 67 of the stop member 60, and the biasing means 64 will automatically pull the stop member 60 back to the first position.

Although the invention has been described as being applied to a vertically sliding double hung window, it is understood the invention can equally be applied to horizontally sliding sash window arrangements or any operable sash window that slides within a frame. It is also understood that the various components of the sash lock assembly can be made from plastic or metal. Plastic components may have integral molded parts, and metal components may have integral cast parts.

It can be appreciated that the anti-rotation device 36 of the present invention will automatically prevent simple rotation of the rotor 34 without additional manipulation of the device 36. The anti-rotation device 36, while not completely intruder-proof, will provide significant deterrence to forced entry and unwanted manipulation of the sash lock assembly 10 from outside the sash window assembly 12. Additionally, the anti-rotation device 36 is simple in construction and operation.

While the specific embodiments have been illustrated and described, numerous modifications come to mind without significantly departing from the spirit of the invention and the scope of protection is only limited by the scope of the accompanying Claims.

What is claimed is:

1. A sash lock assembly for a sash window assembly, the sash window assembly having an upper sash window, a lower sash window slidable within tracks of a master frame, and a keeper connected to the upper sash window, the sash lock assembly comprising:
a housing adapted to be connected to the lower sash window;
a rotor positioned within the housing and moveable between a locked position, wherein the rotor is adapted to engage the keeper, and an unlocked position, wherein the rotor does not engage the keeper;
a handle having a shaft extending through the housing and connected to the rotor, wherein movement of the handle moves the rotor between the locked position and the unlocked position; and
an anti-rotation device operably associated with the housing and comprising a selectable stop member moveable between a first position, wherein the stop member blocks movement of the rotor from the locked position to the unlocked position, and a second position, wherein the stop member does not block movement of the rotor,
wherein the stop member has an abutment surface thereon, the abutment surface engaging the rotor to block movement of the rotor when the stop member is in the first position, wherein engagement of the rotor and the abutment surface forces the stop member toward the first position.

2. The sash lock assembly of claim 1, wherein a gap is maintained between the stop member and the rotor when the rotor is in the locked position and the stop member is in the first position.

3. The sash lock assembly of claim 1, wherein the anti-rotation device further comprises a biasing means contained entirely within the housing, for biasing the stop member toward the first position, the biasing means comprising a mounting arm mounted to a structure on the interior of the housing.

4. The sash lock assembly of claim 3, wherein the mounting arm of the biasing means has a loop connected to a mount passage in the housing adapted to receive a fastener therethrough for connecting the housing to the lower sash window.

5. The sash lock assembly of claim 1, wherein the abutment surface is angled such that when the abutment surface engages the rotor, the abutment surface is substantially perpendicular to the direction of movement of a portion of the rotor engaging the abutment surface.

6. The sash lock assembly of claim 1, wherein the stop member further comprises a contoured surface that engages an outer surface of the rotor when the stop member is in the second position and the rotor is in the unlocked position.

7. The sash lock assembly of claim 6, wherein the rotor has a curved outer surface, and the contoured surface is curved similarly to the outer surface of the rotor to allow the rotor to slide smoothly against the contoured surface when the rotor is moved between the locked position and the unlocked position.

8. A forced entry resistance device for a sash lock assembly for use in a sash window assembly, the sash lock assembly having a housing having a mount passage receiving a fastener for mounting the housing to the sash window assembly, a rotor positioned within the housing and moveable between a locked position and an unlocked position, and a handle connected to the rotor, wherein movement of the handle moves the rotor between the locked position and the unlocked position, the forced entry resistance device comprising:
a stop member adapted to be mounted on the housing and moveable between a first position wherein the stop member is adapted to block movement of the rotor from the locked position to the unlocked position, and a second position, wherein the stop member is adapted to not block movement of the rotor; and
a biasing member connected to the stop member to bias the stop member toward the first position, the biasing member comprising a mounting arm extending from the stop member and adapted to be connected to the mount passage of the housing to mount the biasing member within the housing.

9. The forced entry resistance device of claim 8, wherein the mounting arm has a loop adapted to connect to the mount passage via a boss connection to connect the mounting arm to the housing.

10. The forced entry resistance device of claim 8, wherein the stop member further comprises a contoured surface that engages an outer surface of the rotor when the stop member is in the second position and the rotor is in the unlocked position.

11. The forced entry resistance device of claim 8, wherein the stop member has an abutment surface thereon, the abutment surface engaging the rotor to block movement of the rotor when the stop member is in the first position, wherein engagement of the rotor and the abutment surface forces the stop member toward the first position.

12. The forced entry resistance device of claim 8, wherein at least a portion of the forced entry resistance device is made from a polymer material.

13. The forced entry resistance device of claim 8, wherein at least a portion of the forced entry resistance device is made from a spring steel material.

14. The forced entry resistance device of claim 8, further comprising an actuator extending from the stop member and adapted to extend from a slot in the housing, the actuator having a gripping surface thereon adapted to facilitate manipulation of the stop member by a user.

15. A sash lock assembly for a sash window assembly, the sash window assembly having an upper sash window, a lower sash window slidable within tracks of a master frame, and a keeper connected to the upper sash window, the sash lock assembly comprising:
a housing adapted to be connected to the lower sash window;
a rotor positioned within the housing and moveable between a locked position, wherein the rotor is adapted to engage the keeper, and an unlocked position, wherein the rotor does not engage the keeper;
a handle having a shaft extending through the housing and connected to the rotor, wherein movement of the handle moves the rotor between the locked position and the unlocked position; and
an anti-rotation device operably associated with the housing and comprising a selectable stop member moveable between a first position, wherein the stop member blocks movement of the rotor from the locked position to the unlocked position, and a second position, wherein the stop member does not block movement of the rotor,
wherein the stop member has a contoured surface that engages an outer surface of the rotor when the stop member is in the second position and the rotor is in the unlocked position.

16. The sash lock assembly of claim 15, wherein the rotor has a contoured outer surface, and the contoured surface of the stop member is contoured similarly to the outer surface of the rotor to allow the rotor to slide smoothly against the contoured surface when the rotor is moved between the locked position and the unlocked position.

17. The sash lock assembly of claim 15, wherein the rotor has a curved outer surface, and the contoured surface is curved similarly to the outer surface of the rotor to allow the rotor to slide smoothly against the contoured surface when the rotor is moved between the locked position and the unlocked position.

18. The sash lock assembly of claim 15, wherein the stop member further comprises an abutment surface, the abutment surface engaging the rotor to block movement of the rotor when the stop member is in the first position, wherein the abutment surface is angled such that when the abutment surface engages the rotor, the abutment surface is substantially perpendicular to the direction of movement of a portion of the rotor engaging the abutment surface, forcing the stop member toward the first position.

19. The sash lock assembly of claim 15, wherein the anti-rotation device further comprises a biasing means contained entirely within the housing, for biasing the stop member toward the first position, the biasing means comprising a mounting arm mounted to a structure on the interior of the housing.

20. The sash lock assembly of claim 19, wherein the mounting arm of the biasing means has a loop connected to a mount passage in the housing adapted to receive a fastener therethrough for connecting the housing to the lower sash window.
